(19) United States
(12) Patent Application Publication
(10) Pub. No.: US 2020/0149328 A1
(43) Pub. Date: May 14, 2020

(54) Window Lock

(71) Applicant: Aaron Cohen, Atlantis, FL (US)

(72) Inventor: Aaron Cohen, Atlantis, FL (US)

(21) Appl. No.: 16/563,876

(22) Filed: Sep. 8, 2019

Related U.S. Application Data
(60) Provisional application No. 62/728,588, filed on Sep. 7, 2018.

(51) Int. Cl. E05C 3/16

(52) U.S. Cl. CPC E05C 3/167; E05D 2015/1026

(57) ABSTRACT

According to an embodiment of the disclosure, an improved window lock includes a base hinge, a lever lock, and a base hook. The base hinge includes an adhesive material that allows mounting of the base hinge to either the window being locked or a frame that moves with the window being locked. The lever lock moves with respect to the base hinge with the interface between the two being respective hinge portions. The base hook includes an adhesive material that allows a mounting of base hook to a frame at a particular desired location for locking the window.

This disclosure is generally directed to locks. More specifically, this disclosure is directed to an improved window lock.

### BACKGROUND

People often partially open windows to allow a breeze to circulate through a house. In doing so, they experience increased risk with an intruder illicitly gaining access. This is because the built-in locks for the windows only lock when window is closed. Moreover, conventional approaches at solving the problem have not been satisfactory. Flimsy add-on locks can be easily broken. And, such add-on locks can be bypassed, for example, in a sliding glass window scenario by simply lifting the window up from its tracks.

### BRIEF DESCRIPTION OF THE DRAWINGS

For a more complete understanding of this disclosure and its features, reference is now made to the following description, taken in conjunction with the accompanying drawing, in which:

FIG. 1 shows a perspective view of a window lock 100, according to an embodiment of the disclosure;

FIGS. 2 and 3 illustrate additional aspects of the window lock of FIG. 1, according to an embodiment of the disclosure;

FIGS. 4A and 4B show an alternative configuration of a base hook, according to an embodiment of the disclosure; and

FIGS. 5A and 5B show an alternative configuration of a lever lock, according to an embodiment of the disclosure.

### SUMMARY OF THE DISCLOSURE

Given the concerns with conventional design, an improved window lock has been provided that has a base hinge, a base hinge, and a base hook. Operating as an add-on to a window, the window lock principally prevents movement in X and Y-directions with respect to a plane of the base hinge. Also, secondarily, the window lock also prevents movement in a Z-direction with respect to the plane of the base hinge. To avoid brittle cantilevered scenarios when resisting force, the design includes angle pieces that transfer forces that are imparted thereon.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The phrase “at least one of,” when used with a list of items, means that different combinations of one or more of the listed items may be used, and only one item in the list may be needed. For example, “at least one of: A, B, and C” includes any of the following combinations: A; B; C; A and B; A and C; B and C; and A and B and C. Definitions for certain words and phrases are provided throughout this patent document, those of ordinary skill in the art should understand that in many if not most instances, such definitions apply to prior, as well as future uses of such defined words and phrases.

### DETAILED DESCRIPTION

The FIGURE described below, and the various embodiments used to describe the principles of the present disclosure in this patent document are by way of illustration only and should not be construed in any way to limit the scope of the disclosure. Those skilled in the art will understand that the principles of the present disclosure invention may be implemented in any type of suitably arranged device or system. Additionally, the drawings are not necessarily drawn to scale.

People often partially open windows to allow a breeze to circulate through a house. In doing so, they experience increased risk with an intruder illicitly gaining access. This is because the built-in locks for the windows only lock when window is closed. Moreover, conventional approaches at solving the problem have not been satisfactory. Flimsy add-on locks can be easily broken. And, such add-on locks can be bypassed, for example, in a sliding glass window scenario by simply lifting the window up from its tracks.

Given such concerns, embodiments of the disclosure provide effective window locks that can be added-on as lock retrofit.

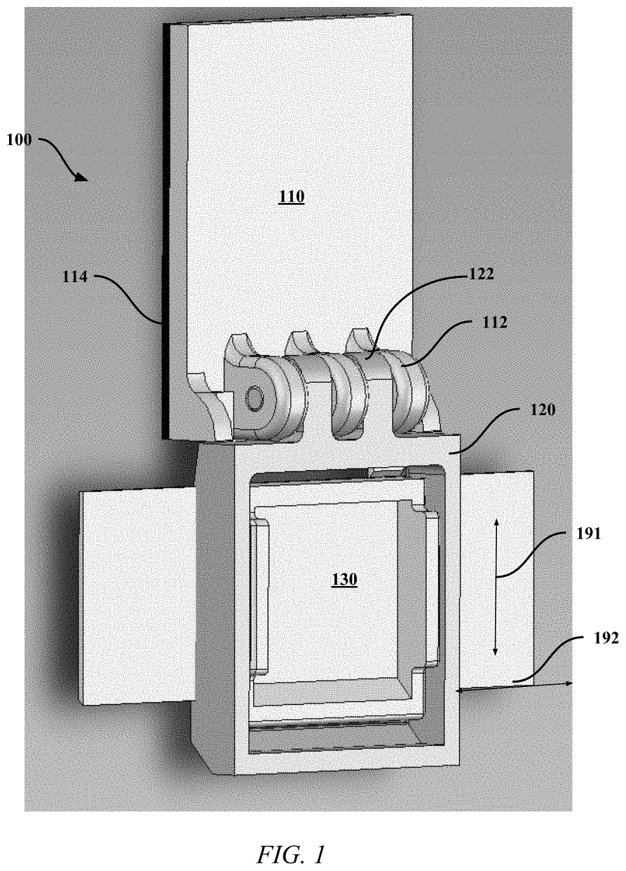

FIG. 1 shows a perspective view of an improved window lock 100, according to an embodiment of the disclosure. The improved window lock 100 generally includes a base hinge 110, a lever lock 120, and a base hook 130.

The base hinge 110 generally includes an adhesive material 114 that allows mounting of the base hinge 110 to either the window being locked or, for example, a frame that moves with the window being locked. In particular configurations, the adhesive material 114 may provide a semi-permanent mounting that can only be removed with great force. In such configurations, one attempting to illicitly remove the base hinge may be prevented from doing so.

The lever lock 120 moves with respect to the base hinge 110 with the interface between the two being respective hinge portions 112 and 122. Although three hinge portions 112 of the base hinge 110 and two hinge portions 122 of the lever lock 120 have been shown, more than or less than this amount may be used in particular configurations.

The base hook 130 generally includes an adhesive material 134 (not seen in this figure) that allows a mounting of base hook 130 to a frame at a particular desired location for locking the window. The adhesive material 134 may have similar properties to the adhesive material 114. As described in more details below, to initially set up the location of the base hook 130, removable portions or guides can be used and clipped (or removed) after placement.

In general operation, the base hinge 110 is mounted on the moveable window being locked, for example using the adhesive material 114. Likewise, on a stationary baseboard, the base hook 130 is mounted at particular desired location for locking the window in place. When unlocked, the base hinge 110 (and corresponding lever lock 120) can move with respect to the base hook 130. To restrict movement between the base hinge 110 and the base hook 130, when the two are aligned, the lever lock 120, which is coupled to the base hinge 110, is positioned on top of the of the base hook 130. When locked, the interaction between the lever lock 120 and base hook 130 restricts both up/down or vertical movement 191 and side-to-side horizontal movement 192 between the two. Such an interaction restricts two degrees of movement (or freedom)—one in the direction of an X-axis (horizontal), and another in the Y-axis (vertical), both with reference to plane of the mounting of the base hinge.

In general operation, one may also have multiple base hooks 130 at different locations. For example, in a sliding patio door use, two different degrees of opening can be configured by placing a base hook 130 in each location. To lock, one simply need slide the patio door to the corresponding base hook 130 and lower the lever lock 120 at the location.

Although the base hook 130 has generally been described as being positioned on the stationary portion (e.g., base board) and the base hinge 110 has generally been described as being positioned on the movable portion (e.g., the window), they may be used in contrary configurations. More specifically, the base hook may be mounted on the movable portion and the base hinge may be mounted on the stationary portion.

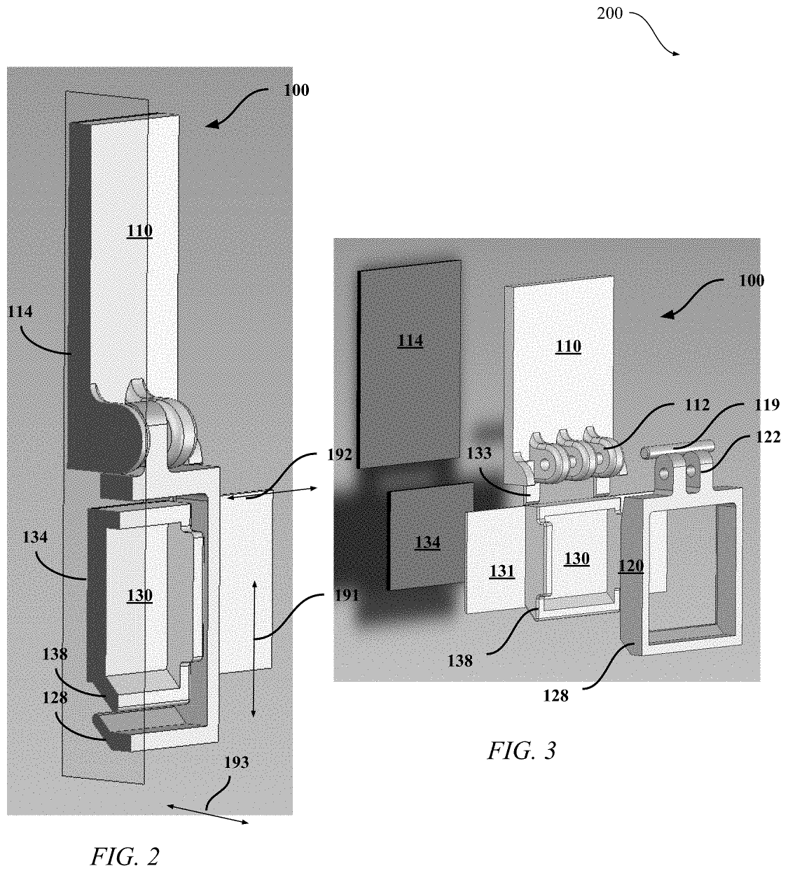

FIGS. 2 and 3 illustrate additional aspects of the window lock 100 of FIG. 1, according to an embodiment of the disclosure. In particular, FIG. 2 shows a cross-section cut across a ghosted plane whereas FIG. 3 shows an exploded view of the various component parts of the window lock 100.

As seen in FIGS. 2 and 3, adhesive material 114 may be used to mount the base hinge 110 and adhesive material 134 may be used to mount the base hooks 130. In particular configurations, the adhesive material 114/134 may respectively be pre-attached to the base hinge 110 and base hook 130 with a removal sheet on the opposite side which exposes the adhesive materials for mounting. An increased surface area as compared to conventional designs reduces the likelihood that the locks will simply be ripped off. While particular sizes have been shown, other sizes may be used in other configurations.

As see in FIGS. 2 and 3, at the lower portion of the base hook 130 is angled portion 138 that corresponds to an angled portion 128 at the lower portion of the lever lock 120. With this configuration a vertical upward movement of the lever lock 120 is resisted. And, any give in the design specifically move such angled portions 128, 138 towards one another. Additionally, the force of an attempted upward movement is transferred through at an angle through the angle portion 128, 138 to the mount of the base hooks as opposed to a cantilevered fashion, which could otherwise result in failure of the window lock 100.

To engage the respective hinge portions 112 and 122, a rod 119 may be used in some configurations.

As seen in FIG. 3, one or both of the portions 131 and 133 may be removed after initial positioning of the base hook 130 with respect to the base hinge 110. As an example, prior to definitely adhering the base hook 130, the base hinge 110 and base hook 130 can be aligned and the lever lock 120 closed. Once such a position is determined, the adhesive 134 can be used to mount the base hook 130. n other configurations, the base hooks 130 may not include portions 131 and 133.

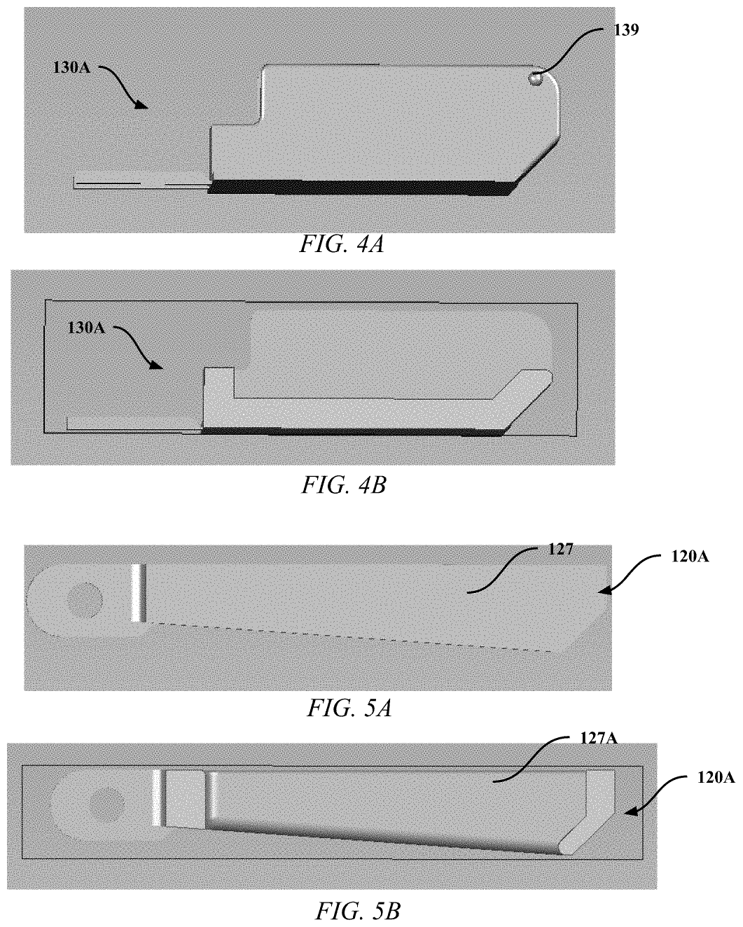

FIGS. 4A and 4B show an alternative configuration of a base hook 130A, according to an embodiment of the disclosure. FIGS. 5A and 5B show an alternative configuration of a lever lock 120A, according to an embodiment of the disclosure. FIGS. 4B and 5B, respectively, show cross sectional view from a ghosted plane of the base hook 130A and lever lock 120A.

The base hook 130A and lever lock 120A work in much the same manner to the base hook 130 and lever lock of FIGS. 1-3 except that the base hook 130A includes a knob 139 that when interacting with the level lock 120A extends just above a wall 127 of the lever lock. The rounding nature of the knob allows it to pass through the interior wall 127A and then after passing, snap into place above the wall. Such a configuration assists further restriction of movement between a base hinge and a base hook, namely along a Z-axis, considering the prior discussion of the X and Y-Axis restrictions with respect to a plane of the base hinge 110.

Additionally, the wall 127 is shown as being thicker away from the hinge than closer to the hinge.

The configurations described herein may be made of a variety of materials, including plastics and metal.

While configurations have been described where both the base hinge and base hook are generally in the same plane, the improved window lock may also be used in scenarios where they are not.

What is claimed is:

1. The apparatus shown and described.
